(19) United States
(12) Patent Application Publication
(10) Pub. No.: US 2021/0055914 A1
(43) Pub. Date: Feb. 25, 2021

(54) COMPUTER DEVICE AND METHOD FOR TESTING IMAGES

(71) Applicant: TRIPLE WIN TECHNOLOGY(SHENZHEN) CO.LTD., Shenzhen (CN)

(72) Inventor: TZONG-YI LEE, New Taipei (TW)

(21) Appl. No.: 16/665,286

(22) Filed: Oct. 28, 2019

(30) Foreign Application Priority Data
Aug. 22, 2019 (CN) 201910780369.1

(51) Int. Cl. G06F 8/30; G06T 7/00

(52) U.S. Cl. CPC G06F 8/30; G06T 2207/30168; G06T 7/0002

(57) ABSTRACT

A method for testing an object by analyzing images thereof includes acquiring an image of an object to be tested, and entering a preset testing algorithm, and setting a script interaction mode as Lua script interaction mode. The method further includes determining whether the preset Lua script needs to be modified for the image of the object according to preset check conditions after invoking a preset Lua script, and modifying the preset Lua script when the preset Lua script needs to be modified. The method further includes invoking the modified preset Lua script, applying the tests to the image by executing the preset testing algorithm; and receiving results of script interaction.

### CROSS-REFERENCE TO RELATED APPLICATIONS

This application claims priority to Chinese Patent Application No. 201910780369.1 filed on Aug. 22, 2019, the contents of which are incorporated by reference herein.

### FIELD

The subject matter herein generally relates to image testing technology field.

### BACKGROUND

An image testing system can acquire a video of an object, and obtain a test result by analyzing the video through test algorithms. Most customer needs are implemented through test algorithms. If the requirements of the test change, the test algorithm needs to be modified. In the software development process, the program source code for modifying the test algorithm usually includes steps of preprocess, compile, assemble, and link. However, the existing method of modification takes time and is not efficient.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a flowchart of an embodiment of a method for testing images of the present disclosure.

FIG. 2 shows one embodiment of modules of an image testing device of the present disclosure.

FIG. 3 shows one embodiment of a schematic structural diagram of a computer device of the present disclosure.

### DETAILED DESCRIPTION

In order to provide a clear understanding of the objects, features, and advantages of the present disclosure, the same are given with reference to the drawings and specific embodiments. It should be noted that non-conflicting embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art as generally understood. The terms used in the present disclosure are for the purposes of describing particular embodiments and are not intended to limit the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

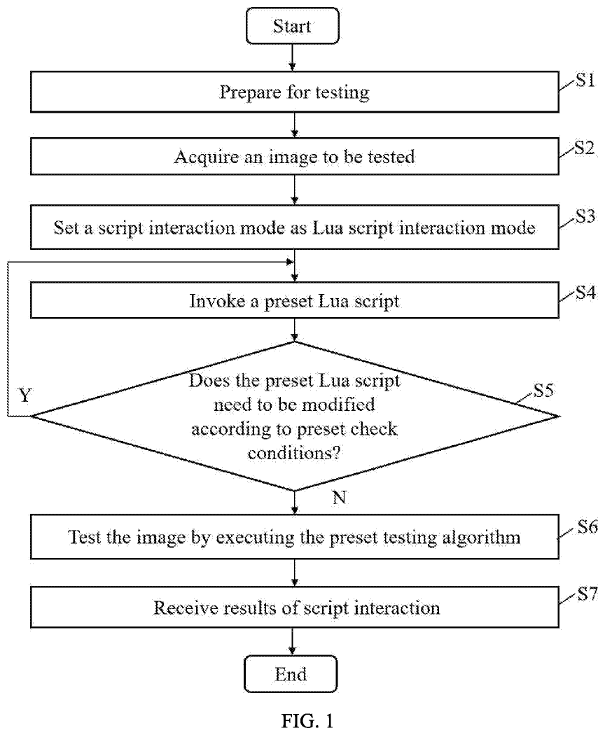

FIG. 1 illustrates a flowchart of one embodiment of a method for testing images of the present disclosure. The image testing method is applied to one or more computer devices. The computer device is a device capable of automatically performing numerical calculation and/or information processing according to an instruction set or stored in advance, and the hardware thereof includes but is not limited to a processor, an external storage medium, a memory, or the like. The image testing method is applicable to an image testing system for acquiring an image of an object and testing the image through a test algorithm to analyze whether the image is qualified or meets a grade requirement.

In at least one embodiment, the computer device 1 may be, but not limited to, a desktop computer, a notebook computer, a cloud server, a smart phone, and the like. The computer device can perform human-computer interaction with the user through a keyboard, a mouse, a remote controller, a touch panel, a gesture recognition device, a voice control device, and the like.

Referring to FIG. 1, the method is provided by way of example, as there are a variety of ways to carry out the method. Each block shown in FIG. 1 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block S1.

At block S1, the computer device 1 can prepare for testing.

In at least one embodiment, after receiving a test requirement, the image testing system can start and prepare for testing.

At block S2, the computer device 1 can acquire an image to be tested.

In at least one embodiment, the image testing system can acquire the image to be tested. The system can enter a preset testing algorithm. The preset testing algorithm can be an algorithm developed in the C/C++/C# language.

At block S3, the computer device 1 can set a script interaction mode as Lua script interaction mode.

In at least one embodiment, since the image testing system can include several script interaction modes, the computer device 1 can set the script interaction mode of the image testing system as the Lua script interaction mode. Lua language is a portable and embeddable scripting language. Advantages of the Lua language are that it is simple and compact, a dynamic language, with extensibility, and embeddable into other languages and cross-platform languages. Compared to other scripting languages, the Lua language can be developed interactively with software developed in other languages, greatly improving the convenience of the software.

At block S4, the computer device 1 can invoke a preset Lua script.

In at least one embodiment, the computer device 1 can store one or more preset Lua scripts according to test requirements. The computer device 1 can invoke the preset Lua script. The preset Lua script can be a default script, or a main Lua script, which can also be a recently updated or recently used Lua script. The Lua script also can be invoked according to other preset rules.

At block S5, the computer device 1 can determine whether the preset Lua script needs to be modified according to preset check conditions.

In at least one embodiment, the computer device 1 can run the preset Lua script and determine whether the preset Lua script needs to be modified for preset check conditions. The preset check conditions can include one or more of types of the object to be tested, an image category, a test item, and a test standard. The types of the object maybe an actual required category index of the product model. For example, the types of the object may include product model, color, size, manufacturer, and so on. If the invoked preset Lua script meets the preset check conditions, the computer device 1 can determine that the preset Lua script does not need to be modified, and the process goes to block S6. If the invoked preset Lua script does not meet the preset check conditions, the computer device 1 can determine that the preset Lua script needs to be modified, the process can return to block S4, and the computer device 1 can invoke a modified Lua script.

For example, the preset check conditions can include the product model and the test item, and the product model is A. The test item can include an area and size of the product. If the image to be tested is an image of product A and the test item is the area and size of the product A, the computer device 1 can determine that the preset Lua script does not need to be modified. If the image to be tested is an image of product B and the test item is a product B or other item, the computer device 1 can determine that the preset Lua script needs to be modified.

In at least one embodiment, the modified Lua script can be a Lua script obtained by adding or modifying content of the invoked Lua script, newly added Lua script, or other preset Lua script for recall.

In at least one embodiment, the method further includes a step for modifying the preset Lua script when the computer device 1 determines that the preset Lua script needs to be modified. The step for modifying the preset Lua script may be to modify the preset Lua script according to one or more of the types of the object to be tested, the image category, the test item, and the test standard.

For example, in the block S4, test items of the invoked preset Lua script are area and size of the product, and the test items of the acquired image of block S2 further includes quantity of the products. Then, the computer device 1 can add the quantity of the products to the invoked preset Lua script.

At block S6, the computer device 1 can test the image by executing the preset testing algorithm.

In at least one embodiment, the invoked Lua script is embedded in the test algorithm, and the test algorithm is executed to test the image.

At block S7, the computer device 1 can receive results of script interaction.

In at least one embodiment, the results of script interaction can include whether the image is qualified or not. For example, whether the image has flaws or is flawless. Furthermore, the results of script interaction can include whether the image reaches the desired quality level. Then, the computer device 1 can determine the quality level of the product corresponding to the image.

In at least one embodiment, the results of script interaction further can include whether the test is successful. If the test is successful, the computer device 1 can store the test algorithm carrying the embedded invoked Lua script. Then, the computer device 1 can test similar products. If the test is a failure, the computer device 1 can add a new Lua script, or add new content to the preset Lua script, or modify the preset Lua script, and restart the above process.

In at least one embodiment, after the block S1, the method further includes a step for receiving one or more kinds of categories, image categories, test items, and test standards of the product to be tested, in order to facilitate the determinations in step S4.

In at least one embodiment, the image testing method can embed the Lua scripting language into the image testing system, realize the interactive development of the Lua scripting language and the image testing system, and increase the function of the image testing system and achieve more customization as the Lua scripting language is flexible. The function is not required to modify the test algorithm of the original image test system. The modification of the Lua script does not require recompilation, which can save time and improve efficiency. The Lua scripting language is easier to learn, allowing more engineers to learn and reducing development costs. The above image testing method is more convenient when updating the content of the image test system, and only the Lua script language portion needs to be updated.

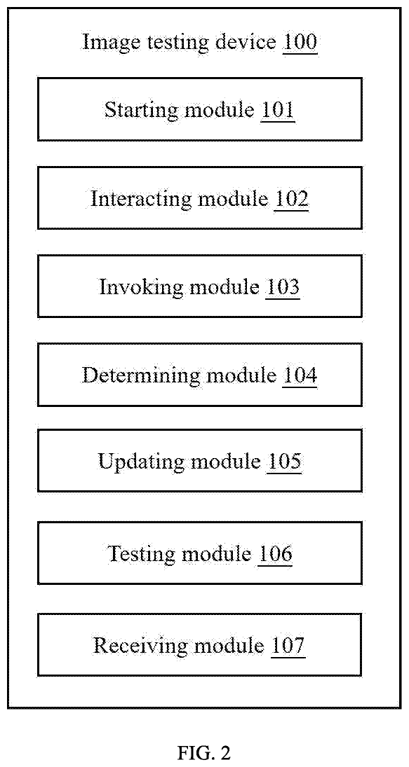

FIG. 2 shows an embodiment of modules of an image testing device of the present disclosure.

In at least one embodiment, the image testing device 100 can include a plurality of modules. The plurality of modules can include, but is not limited to a starting module 101, an interacting module 102, an invoking module 103, a determining module 104, an updating module 105, a testing module 106, and a receiving module 107. The modules 101-107 can comprise computerized instructions in the form of one or more computer-readable programs that can be stored in the non-transitory computer-readable medium (e.g., the storage device of the computer device), and executed by the at least one processor of the computer device to implement the functions (e.g., described in detail in FIG. 1).

The starting module 101 can acquire an image to be tested, and enter a preset testing algorithm. The preset testing algorithm can be an algorithm developed by the C/C++/C# language.

The interacting module 102 can set a script interaction mode as Lua script interaction mode after entering the preset testing algorithm.

The invoking module 103 can invoke the preset Lua script after setting the script interaction mode as Lua script interaction mode. The invoking module 103 can invoke one or more Lua scripts according to test requirements.

The invoking module 103 further can invoke a modified preset Lua script. The modified preset Lua script may be a Lua script obtained by adding or modifying the content of the invoked Lua script, a new Lua script, or other preset Lua scripts.

The determining module 104 can determine whether the preset Lua script needs to be modified according to preset check conditions. The preset check conditions can include one or more of types of the object to be tested, an image category, a test item, and a test standard.

The updating module 105 can add or modify content of the Lua script, and add new Lua script.

The testing module 106 can test the image by executing the preset testing algorithm.

The receiving module 106 can receive results of script interaction. The results of script interaction can include results of whether the image is qualified or not. The results of script interaction can include results of whether the image indicates achievement of the desired quality level. The results of script interaction further can include results of whether the test is successful.

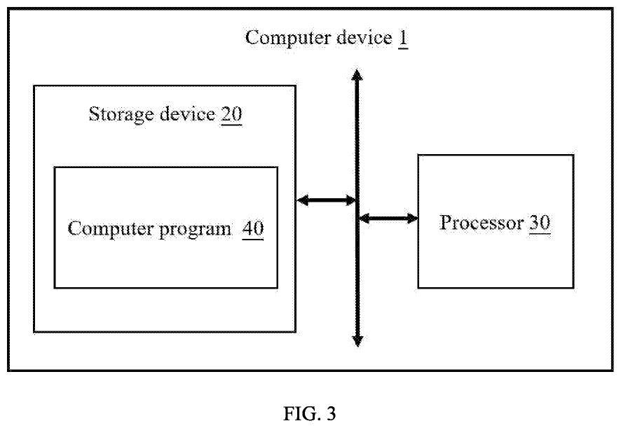

FIG. 3 shows one embodiment of a schematic structural diagram of a computer device. In an embodiment, a computer device 1 includes a storage device 20, at least one processor 30, and a computer program 40, such as an image testing program, stored in the storage device 20, and executable on the processor 30. When the processor 30 executes the computer program 40, the steps in the foregoing image testing method embodiment are implemented, for example, steps S1 to S7 shown in FIG. 1. Alternatively, when the processor 30 executes the computer program 40, the functions of the modules in the above-described monitoring device embodiment are implemented, such as functions of the modules 101-107 in FIG. 2.

In at least one embodiment, the computer program 40 can be partitioned into one or more modules/units that are stored in the storage device 20 and executed by the processor 30. The one or more modules/units may be a series of computer program instruction segments capable of performing a particular function for describing the execution of the computer program 40 in the computer device 1. For example, the computer program 40 can be divided into the starting module 101, the interacting module 102, the invoking module 103, the determining module 104, the updating module 105, the testing module 106, and the receiving module 107 in FIG. 2. Details of the functions of the respective modules are shown in FIG. 2.

In at least one embodiment, the computer device 1 may be a computing device such as a desktop computer, a notebook, a palmtop computer, or a cloud server. It should be noted that the computer device 3 is merely an example, other existing or future electronic products may be included in the scope of the present disclosure, and are included in this reference. Components, such as the computer device 1, may also include input and output devices, network access devices, buses, and the like.

In some embodiments, the at least one processor 30 may be a central processing unit (CPU), and may also include other general-purpose processors, digital signal processors (DSPs), application specific integrated circuits (ASICs), and off-the-shelf programmable gate arrays, Field-Programmable Gate Array (FPGA) or other programmable logic device, discrete gate, or transistor logic device, discrete hardware components, etc. The general-purpose processor may be a microprocessor or the processor may be any conventional processor or the like. The processor 30 is control center of the computer device 1, and connects sections of the entire computer device 1 with various interfaces and lines.

In some embodiments, the storage device 20 can be used to store program codes of computer readable programs and various data, such as the image testing device 100 installed in the computer device 1. The storage device 20 can include a read-only memory (ROM), a random access memory (RAM), a programmable read-only memory (PROM), an erasable programmable read only memory (EPROM), a one-time programmable read-only memory (OTPROM), an electronically-erasable programmable read-only memory (EEPROM)), a compact disc read-only memory (CD-ROM), or other optical disk storage, magnetic disk storage, magnetic tape storage, or any other storage medium readable by the computer device 1.

The modules/units integrated by the computer device 1 can be stored in a computer readable storage medium if implemented in the form of a software functional unit and sold or used as a stand-alone product. The present disclosure implements all or part of the processes in the foregoing embodiments, and a computer program may also instruct related hardware. The computer program may be stored in a computer readable storage medium. The steps of the various method embodiments described above may be implemented by a computer program when executed by a processor. Wherein, the computer program comprises computer program code, which may be in the form of source code, product code form, executable file, or some intermediate form. The computer readable medium may include any entity or device capable of carrying the computer program code, a recording medium, a USB flash drive, a removable hard disk, a magnetic disk, an optical disk, a computer memory, a read-only memory (ROM), random access memory (RAM, Random Access Memory), electrical carrier signals, telecommunications signals, and software distribution media. It should be noted that the content contained in the computer readable medium may be increased or decreased according to the requirements of legislation and patent practice in a jurisdiction, for example, in some jurisdictions, computer-readable media does not include electrical carrier signals and telecommunication signals.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed is:

1. An image testing method applicable in a computer device, the method comprising:
acquiring an image to be tested, and entering a preset testing algorithm;
setting a script interaction mode as Lua script interaction mode;
invoking a preset Lua script;
determining whether the preset Lua script needs to be modified according to preset check conditions;
modifying the preset Lua script when the preset Lua script needs to be modified;
invoking the modified preset Lua script;
testing the image by executing the preset testing algorithm; and
receiving results of script interaction.

2. The method according to claim 1, wherein the modified preset Lua script comprising a Lua script obtained by adding or modifying the content of the invoked Lua script, a new Lua script, or other preset Lua scripts.

3. The method according to claim 1, wherein the results of script interaction comprising results of whether the image is qualified or not, results of whether the image reaches a desired quality level, and results of whether the test is success.

4. The method according to claim 1, wherein the preset check conditions comprising one or more of types of an object to be tested, an image category, a test item, and a test standard.

5. The method according to claim 1, wherein the method further comprising:
testing the image by executing the preset testing algorithm when the preset Lua script does not need to be modified.

6. The method according to claim 4, wherein the method further comprising:
modifying the preset Lua script according to one or more of the preset check conditions when the preset Lua script needs to be modified.

7. A computer device comprising:
a storage device;
at least one processor; and
the storage device storing one or more programs that, when executed by the at least one processor, cause the at least one processor to:
acquire an image to be tested, and enter a preset testing algorithm;
set a script interaction mode as Lua script interaction mode;
invoke a preset Lua script;
determine whether the preset Lua script needs to be modified according to preset check conditions;
modify the preset Lua script when the preset Lua script needs to be modified;
invoke the modified preset Lua script;
test the image by executing the preset testing algorithm; and
receive results of script interaction.

8. The computer device according to claim 7, wherein the modified preset Lua script comprising a Lua script obtained by adding or modifying the content of the invoked Lua script, a new Lua script, or other preset Lua scripts.

9. The computer device according to claim 7, wherein the results of script interaction comprising results of whether the image is qualified or not, results of whether the image reaches a desired quality level, and results of whether the test is success.

10. The computer device according to claim 7, wherein the preset check conditions comprising one or more of types of an object to be tested, an image category, a test item, and a test standard.

11. The computer device according to claim 7, wherein the at least one processor is further caused to:
test the image by executing the preset testing algorithm when the preset Lua script does not need to be modified.

12. The computer device according to claim 10, wherein the at least one processor is further caused to:
modify the preset Lua script according to one or more of the preset check conditions when the preset Lua script needs to be modified.

13. A non-transitory storage medium having stored thereon instructions that, when executed by a processor of a computer device, causes the processor to perform an image testing method, the method comprising:
acquiring an image to be tested, and entering a preset testing algorithm;
setting a script interaction mode as Lua script interaction mode;
invoking a preset Lua script;
determining whether the preset Lua script needs to be modified according to preset check conditions;
modifying the preset Lua script when the preset Lua script needs to be modified;
invoking the modified preset Lua script;
testing the image by executing the preset testing algorithm; and
receiving results of script interaction.

14. The non-transitory storage medium according to claim 13, wherein the modified preset Lua script comprising a Lua script obtained by adding or modifying the content of the invoked Lua script, a new Lua script, or other preset Lua scripts.

15. The non-transitory storage medium according to claim 13, wherein the results of script interaction comprising results of whether the image is qualified or not, results of whether the image reaches a desired quality level, and results of whether the test is success.

16. The non-transitory storage medium according to claim 13, wherein the preset check conditions comprising one or more of types of an object to be tested, an image category, a test item, and a test standard.

17. The non-transitory storage medium according to claim 13, wherein the method further comprising:
testing the image by executing the preset testing algorithm when the preset Lua script does not need to be modified.

18. The non-transitory storage medium according to claim 16, wherein the method further comprising:
modifying the preset Lua script according to one or more of the preset check conditions when the preset Lua script needs to be modified.
